(19) United States
(12) Patent Application Publication
(10) Pub. No.: US 2009/0108963 A1
(43) Pub. Date: Apr. 30, 2009

(54) Integral variable termination for alarm system devices

(76) Inventor: Mark A. Lasky, Riverwoods, IL (US)

Correspondence Address: LAW OFFICE OF GARY LIGHT, P.C.;ATTN: PETER PAPAVASILIOU, 1701 E. LAKE AVE. #345, GLENVIEW, IL, 60025, US

(21) Appl. No.: 11/978,747

(22) Filed: Oct. 30, 2007

(51) Int. Cl. H01P 1/22

(52) U.S. Cl. 333/22 R

(57) ABSTRACT

Disclosed is a system for quickly and easily installing end-of-line termination devices at the end of alarm system signal circuits. The termination devices in this invention are both variable and integral to the housing of the alarm system devices. Each alarm system device is constructed with a receptacle at the point of protection, in which may be placed a cartridge, jumper, or similar device on-site to terminate the communication signal. The various embodiments of the invention include a set of devices at discrete values or a variable device to complete each protection loop.

### FIELD OF INVENTION

The invention concerns security systems, including but not limited to burglar, fire alarm, and access control systems, and similar systems. In such systems, protection loops to peripheral devices must be terminated with termination devices. This invention applies particularly to a novel way of installing these termination devices.

### BACKGROUND OF THE INVENTION

This invention concerns systems such as burglar, fire alarm, and access control systems, and similar systems, in which peripheral devices are connected to a control panel for monitoring, and the peripheral is terminated with an End-of-Line (EOL) component, which is usually, but not always, a resistor. The EOL component, or termination device, varies both in type and value based on the control panel manufacturers' selections.

In the prior art, an electrician or device installer must manually connect the termination device to the circuit, either by soldering or by connection to a set of electrical terminals or by some other means. This process is tedious, because each termination device must be individually selected and manually installed at remote locations, and as a result many installers simply install the EOL component at the panel, largely defeating its purpose. Hand-installed devices have a tendency to fail, and faulty EOL termination at the panel can cause false alarms on the system or render the protection loop useless by failing to report an alarm state that is present.

Most alarm system faults due to faulty wiring occur in one of two ways: either there is a short circuit on the system because faulty wiring makes contact with grounded components, producing a “short circuit fault”, or the contact between system components is broken, resulting in an “open circuit” fault on the system. Both faults are problematic, as most alarm systems see “open circuit” faults as triggered false alarms, while “short circuit” faults can cause an actual alarm to go unreported if the terminating device is installed in the wrong position, i.e. at the control panel.

It is possible to pre-install termination devices within the peripheral devices, but because termination devices vary greatly by manufacturer, it is usually necessary to special-order these devices, which can cause delays and added cost to a project.

The present invention consists of a simpler method of installing termination devices on security system protection loops, reducing the potential for both errors and delays in the process of installing EOL components in such systems.

### SUMMARY OF THE INVENTION

The present invention comprises a means of adding a termination device to a peripheral system device directly, by modifying the device itself to accept termination devices of varying types and limited values. The external housing of the peripheral component must be modified with the addition of a coupler connector to accept a jumper, cartridge, or other form of device containing the appropriate EOL component. This connector allows the termination device to be attached directly to the peripheral system device itself, not manually added to the protection loop wiring, and ensures proper connection at the end of the circuit, which in turn ensures full EOL supervision. The invention also allows for field installation of a variety of termination devices, which are designed to couple quickly and effortlessly with the coupler connector prior to installation of the peripheral device.

### BRIEF DESCRIPTION OF THE SEVERAL VIEWS OF THE DRAWING

FIG. 1 depicts a typical alarm system protection loop, with a terminating device at the end of the line.

FIG. 2 depicts the proposed alarm system with a terminating device within the peripheral system component furthest from the control panel.

FIG. 3 is a diagram of a typical installation of a peripheral system component.

FIG. 4 is a top view of the proposed invention.

FIG. 5 is a cross section of the proposed invention taken alone section line A-A, employing a threaded cartridge embodiment of the invention.

FIG. 6 is a cross section of the proposed invention taken along section line A-A, employing a jumper embodiment of the invention.

FIG. 7 is a cross section of the proposed invention taken along section line A-A, employing a snap-on cartridge embodiment of the invention.

### DETAILED DESCRIPTION OF THE INVENTION

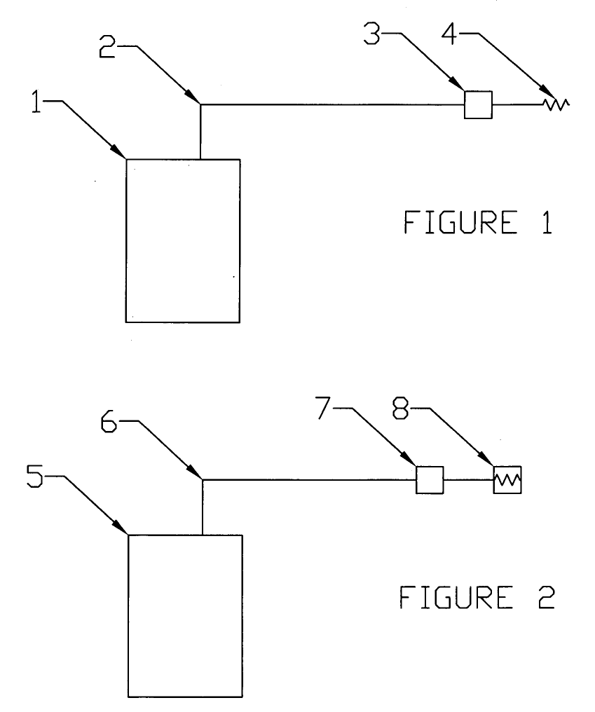

FIG. 1 depicts the typical alarm system layout in use in the prior art. A signal originates from a control panel (1) and travels down a signal wiring protection loop (2) to one or more peripheral system components (3). The signal is then terminated by a termination device (4), often a manually installed resistor, which is necessary to ensure maximum signal integrity. However, because of the nuisance of installing these devices at multiple remote locations, it is not uncommon for electricians to install termination devices within the control panel (1), which, while functional in a normal state, may cause false alarms or render the entire protection loop useless in the event of an actual alarm if the installation of the termination device is faulty.

FIG. 2 depicts the proposed alarm system layout using the present invention. Again, the signal originates from a control panel (5) and travels down a signal wiring protection loop (6) and may be received by a number of intermediate peripheral system components (7). However, using the present invention, the terminating device in this circuit is located within the last peripheral system component (8) on the protection loop. Since the installer is going to have to install this peripheral system component (8) anyway, there is no additional work required to terminate the system properly, thus eliminating the temptation to terminate the protection loop in the control panel. (5)

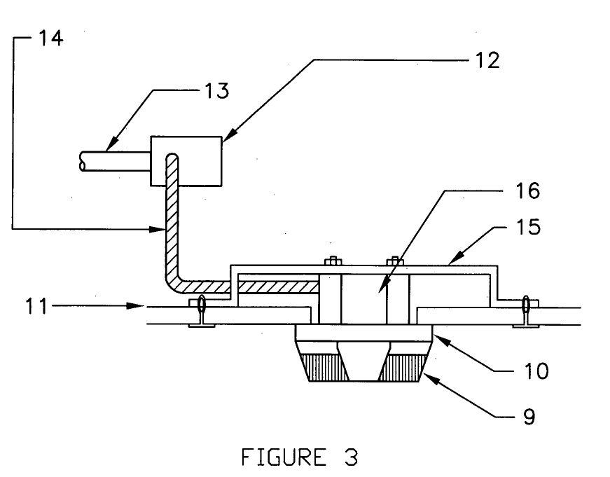

FIG. 3 depicts a cross section of a typical alarm system peripheral system component installation. In this example, the signal wires are housed in conduit (13) and pass through a junction box, (12) electrical metal tubing, (14) and typically an octagonal junction box (16) to which the peripheral system component (9) is mounted. In many municipalities, conduit, (13) junction boxes, (12) and electrical metal tubing (14) are not required by local codes and are often not installed. The octagonal junction box (16) is typically mounted on a bracket (15) which is attached to the ceiling, (11) and holds the backplate (10) of the peripheral system component flush with the ceiling (11).

The conduit, (13), junction box, (12) electrical metallic tubing, (14) bracket (15), and octagonal junction box (16) in FIG. 3 are metallic, electroconductive, and grounded, and any faulty wiring that makes contact with these will cause a fault in the alarm system. The typical location in which termination devices are located in modern alarm system devices is either within an octagonal junction box (16) or within the junction box (12) on the conduit (13). The termination device in the present invention is located, in most embodiments, on the backplate (10) within the peripheral system device (9) itself, which is nonconductive and does not present this risk. This invention thus greatly decreases the risk of “short circuit” faults.

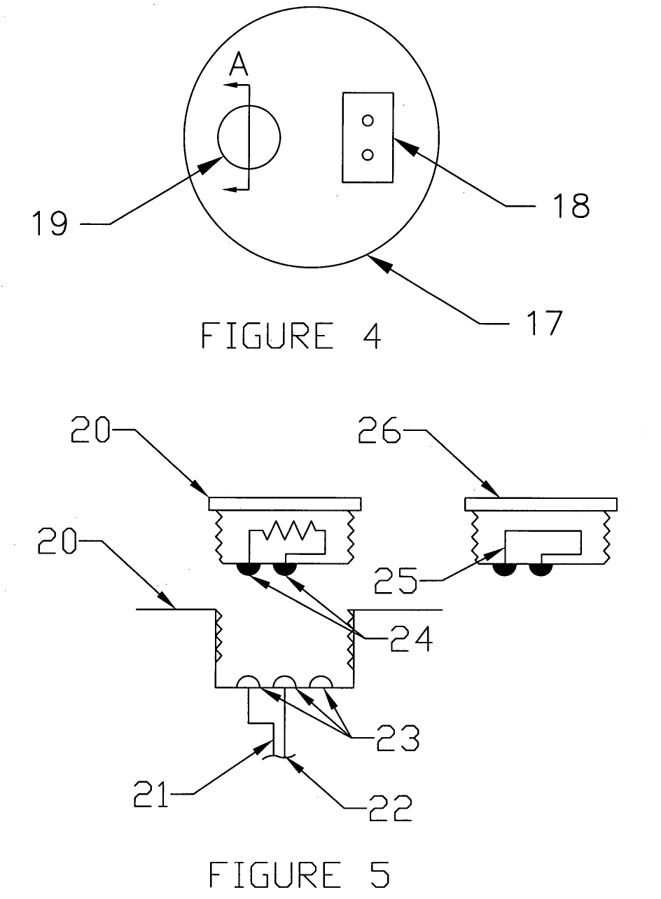

FIGS. 4, 5, 6, and 7 depict three possible embodiments of the present invention. FIG. 4 shows the typical underside of a peripheral system component (17). A terminal block (18) which receives the signal wire connections is located somewhere on the underside of the peripheral system component. (17) These embodiments of the present invention also feature a compartment (19) for a termination device elsewhere on the underside of the peripheral system component. (17)

FIG. 5 depicts an embodiment of the invention in which the termination device (20) is threaded and inserted into a threaded compartment, (21) much like a modern light bulb. Where termination is required, a terminating device (20) is inserted into the compartment, and electrical contacts (24) on the terminating device (20) engage similar electrical contacts (23) in the compartment (19). Signal wiring (21) thus connected to the electrical contacts (24) on the termination device (20) lead back to the protection loop (22) through the terminal block (18) on the underside of the peripheral system device (17). Where termination is not necessary, as in any intermediate peripheral system devices, a pass-through cartridge (26) which has a short-circuit (25) in place of the termination device is installed in the compartment. (19)

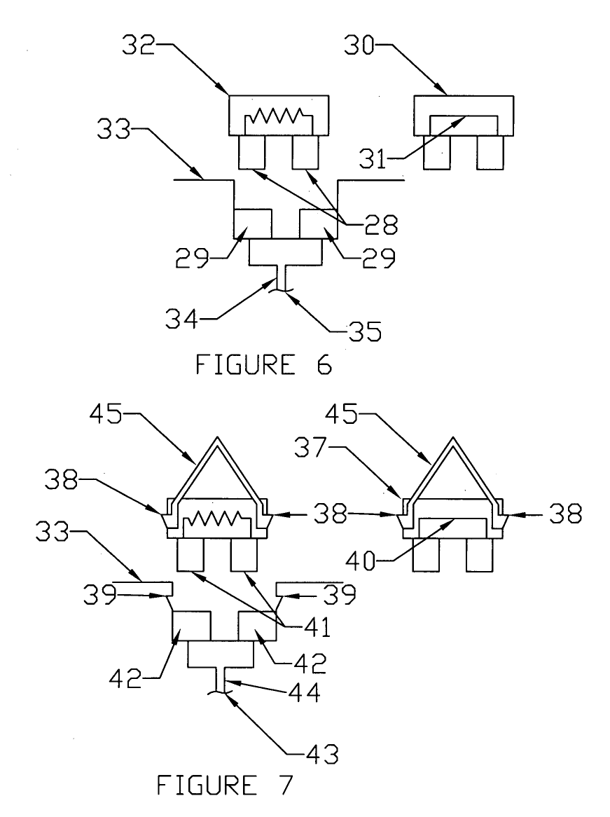

FIG. 6 depicts an embodiment of the invention similar to that of FIG. 5, but in this embodiment, a terminating jumper (32) is used to terminate the protection loop (35). The jumper makes electrical contact by means of a pair of blades (28) which contact a two-pronged receptacle (29) within the compartment (19). Like the previous embodiment, devices can be fitted with a pass-through jumper (30) in which the two blades (28) are connected to one another by a short circuit (31). The jumpers are connected to the terminal block (18) and thus the rest of the system by signal wiring (34).

FIG. 7 depicts an embodiment of the invention similar to that of FIGS. 5 and 6, but in which the terminating device is housed in a snap-on cartridge (37). This device makes connection by a set of leads (41) connecting to a receptacle (42) attached to signal wiring (34) similar to those of FIG. 6. The enclosure of the snap-on cartridge, however, is fitted to the compartment (19) and locks into it by means of a set of protrusions (38) which engage notches (39) within the compartment. A mechanism (45) for withdrawing the protrusions (38) and removing the cartridge (37) is also present. A pass-through cartridge employing a short-circuit (40) may be used where the protection loop (43) is not to be terminated.

As an alternative to removable cartridges, a potentiometer, a dual in-line package device connected to varying termination devices, or similar adjustable device could be installed in the housing (9) of the peripheral system device, allowing the installer to easily change the termination device value at the peripheral system device.

What is claimed is:

1. An internal device for a peripheral system component comprising:
a termination device integral to the peripheral component; and
a means of changing the termination device to provide for a range of possible termination values.

2. The device of claim 1, wherein the termination device is resistive.

3. The device of claim 1, wherein the termination device is a jumper.

4. The device of claim 1, wherein the termination device is enclosed in a cartridge which attaches to the housing of the peripheral system component.

5. An internal device for a peripheral system component comprising:
A termination device attached to the peripheral component; and
said termination device being adjustable to provide for a range of possible termination values.

6. The device of claim 5, wherein the termination device is a potentiometer.
